(19) United States
(12) Patent Application Publication
(10) Pub. No.: US 2009/0031037 A1
(43) Pub. Date: Jan. 29, 2009

(54) METHOD OF STREAMING MEDIA AND INSERTING ADDITIONAL CONTENT THEREIN USING BUFFERING

(75) Inventors: Jordan Mendell, Denver, CO (US); Timothy Shay, Salisbury, NC (US); Brian Burrows, Myakka City, FL (US)

Correspondence Address: BARLOW, JOSEPHS & HOLMES, LTD., 101 DYER STREET, 5TH FLOOR, PROVIDENCE, RI, 02903, US

(73) Assignee: ANDO MEDIA, LLC, Housatonic, MA (US)

(21) Appl. No.: 12/112,023

(22) Filed: Apr. 30, 2008

Related U.S. Application Data
(60) Provisional application No. 60/914,874, filed on Apr. 30, 2007.

(51) Int. Cl. G06F 15/16

(52) U.S. Cl. 709/231

(57) ABSTRACT

A method and system of streaming media content is disclosed. The method and system includes a process step and structures for inputting the live feed into a first audio card having an output. Another process step and structures are provided for inputting the output of the first audio card into a FIFO buffer having an output. Another process step and structures are provided for inputting the output of the FIFO buffer into a virtual audio card having an output. Another process step and structures are provided for inserting additional content into a second audio card by replacing content to be substituted where the additional content and the content to be replaced do not have to be of the same duration. Another process step and structures are provided for mixing the output from the first audio card and the additional content by the second audio card to provide a mixed output. Another process step and structures are provided for inputting the mixed output of the second audio card into an encoder having an output. Another process step and structures are provided for streaming the output of the encoder over a network.

### CROSS-REFERENCE TO RELATED APPLICATION

The present patent document claims the benefit of the filing date of earlier filed U.S. Provisional Patent Application Ser. No. 60/914,874, filed on Apr. 30, 2007, the entire contents of which are incorporated by reference herein.

### BACKGROUND OF THE INVENTION

The present invention generally relates to the insertion of audio and video into an Internet broadcast. More specifically, the present invention relates to the insertion of audio and video advertisements into an Internet broadcast.

In the Internet broadcast industry, content is delivered to user in different forms, such as audio and video. For ease of illustration herein, the invention will be discussed in detail in connection with the broadcast of audio over the Internet but it should be understood that the invention can be applied to the delivery of video over the Internet as well.

The broadcast of audio over the Internet is frequently used to deliver, for example, a radio-type broadcast. This may include music and speech, and the like. Periodically, just like terrestrial radio, it is desirable to deliver advertising to the user. To carry out such advertising during an Internet broadcast, ease of delivery of the advertisement and access by the user as well as reporting and logging are all critical to for effective advertising in this medium.

There have been many attempts in the prior art to use advertising during an Internet broadcast. One of the most common methods is called stream switching which is simply the use of multiple different streams, some for the primary broadcast and other streams for advertising. When an advertisement is required, the broadcast stream is terminated and the advertisement stream is started. When the delivery of the advertisement is completed, the broadcast stream is restarted. Thus, each time an advertisement is desired, the current stream must be terminated and the advertisement stream started then stopped. The major drawback to such stream switching is that each time a stream is started, the user's media player must buffer the stream before the audio can be heard causing an undesirable silence each time a stream is switched. Thus, in this scenario, a media server is handling the switching of the streams.

Another attempt to deliver advertisements involves the placement of such advertisements within the broadcaster's playlist. This insertion of the advertising is done prior to the delivery of the audio to the encoder for stream. The broadcasting radio station inserts the advertisements manually where desired so that the stream provided for encoding and delivery via the Internet already has the advertising content therein. For example, an Internet radio station typically has a playlist of songs that is going to retrieve a song file that is first played and then inputted into the encoder for Internet broadcast. The station may wish to play an advertisement each time after it plays 10 songs, for example. Thus, the radio station will have to manually include an advertisement in its playlist to retrieve and play the desired advertisement audio file. Thus, an advertisement in this method is indistinguishable from a normal song. While, playlist manipulation is seamless to the encoder and to the user and does not have the undesirable long periods of silence between streams in a stream switching method, the manual insertion of advertisements into a playlist is very labor intensive and provides no automatic reporting and logging of the advertisement for accounting and tracking purposes and cannot track broadcaster statistics.

Therefore, there is a desire for a method and system for inserting multimedia (such as audio) into a multimedia (audio) stream that is seamless and continuous in delivery to the user. There is also a desire for such a method for easy accounting for tracking and logging advertisements and the statistics associated therewith.

### SUMMARY OF THE INVENTION

The present invention solves the problems associated with prior art methods for streaming media and inserting additional content therein. It should be understood that the method and system of the present invention has particular application in inserting any type of media, such as audio or video, into any type of media stream whether it contains advertising content or not. However, it has the most applicability in inserting advertising multimedia and specialized content into an existing multimedia stream.

In accordance with the present invention, a unique method and system is provided that is superior to the prior art methods and systems discussed above. The method and system of the present invention provides a unique way to insert clips, such as advertisements, into an existing stream without disrupting the stream or requiring the user to manually insert the advertisement into a playlist for later encoding. Also, the inserted media does not need to be of the same length as the material it is replacing to provide a seamless media stream to the user.

### BRIEF DESCRIPTION OF THE DRAWINGS

These and other features, aspects, and advantages of the present invention will become better understood with reference to the following description, appended claims, and accompanying drawings where:

FIG. 1 is a flowchart showing an embodiment the method of the present invention;

FIG. 2 is a flowchart showing an alternative embodiment of the method of the present invention; and

FIG. 3 is a flowchart showing an overview of an implementation of the method of the present invention.

### DETAILED DESCRIPTION OF THE PREFERRED EMBODIMENTS

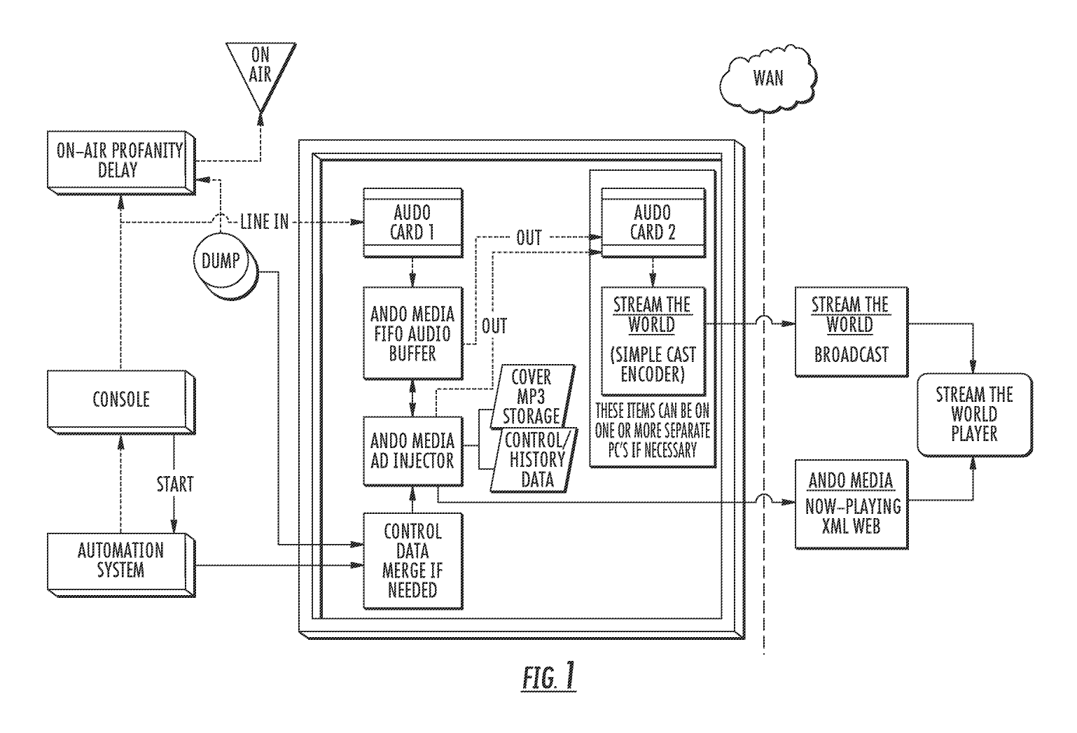

Referring to FIGS. 1-3, the present invention is a method and system that includes a number of different components that can deliver a seamless media stream with content and content inserted therein. As seen in FIG. 1, an audio card receives audio from a console that is controlled by an automation system. A dump and profanity delay are included. The output of the audio card is fed into an unique FIFO buffer, which is a real time audio mixing application, allowing for real time, and post processing audio manipulation and DSP. It is preferably written in the C# programming language using managed Software Development Libraries. However, other languages can be used, if desired. As part of the system, kernel API calls are imported when required. The machine code is compiled to target X86, and run under Microsoft Windows 2000, XP, Server2003, and Vista Platforms. The application includes the ability to control the operational logic by local console commands, as well as remote control via TCP Sockets.

Upon initial execution, the system configuration is set using a simplified interactive wizard, allowing the user to quickly enable and utilize the system. The configuration chosen, is stored locally using an XML configuration file, and upon subsequent executions, is reloaded without any need for user input. Custom classes implementing Microsoft DirectX, DirecShow, as well as windows Media Format SDK are used to seamlessly interact with almost any audio hardware supported under the available operating system. Once the initial configuration is complete, and the application is in a run state, audio is fed from the selected device, and physical input, decoded into raw PCM format, and held in an efficient circular buffer. In this fashion, data access to the playback functions is facilitated which are directed to the selected audio device output.

Live audio playback can be paused, causing the recording input to fill the buffer further, and at any point audio playback may be resumed, pulling from the buffer first, effectively allowing the listener to resume where they left off listening.

In combination with the above, live recording can also be paused, allowing the buffer to be drained, until it is empty, ultimately resulting in silence. One can also use these two mechanisms to create a sliding window of audio, controlling input and output independently.

With the ability to start and stop, input and output, the ability to read the size of the internal buffer, as well as flush it when needed also exist.

There are also predefined commands, allowing for x seconds of audio to be removed from the audio buffer. This allows for automation applications to be developed in any language, communicating via TCP Sockets, to act as additional control logic.

Advanced error alerts are incorporated into the design. Emails as well as HTTP POST's containing all pertinent information may be triggered. Along with this, we have implemented a silence detection system. By analyzing the raw PCM data coming in from the recording device, the audio volume in decibels is calculated in real time. If the level falls below a user defined limit, for a given amount of time, a silence event is triggered, which may be delivered via Email or an HTTP POST.

Audio content archiving, for QA or preservation purposes is provided by a in process MP3 encoder. At any time, a command may be issued to start, stop, pause, or resume the encoder. The encoded bitrate, ID3, and additional parameters are configured in the above mentioned XML file. The user can issue a new file command, forcing the encoder to begin writing a new file, in which the timestamp is part of the filename. Automatic FTP transferring of the resultant mp3 file is facilitated using an independent worker thread, to ensure high availability of the audio processors.

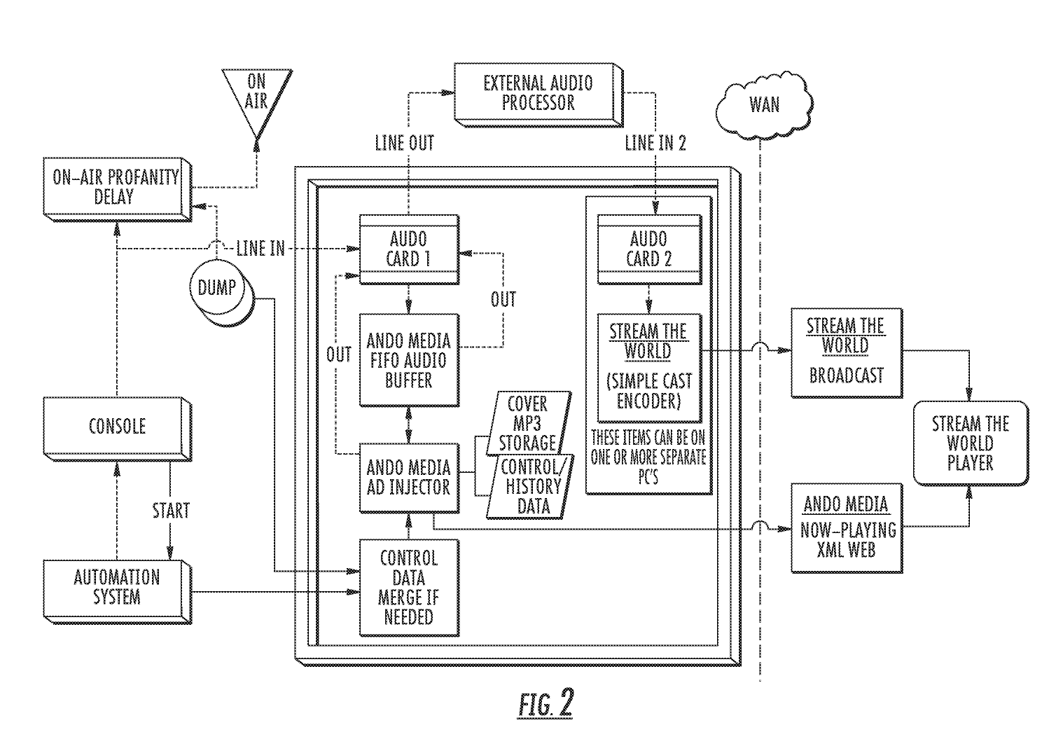

Still referring to FIG. 1, content can also be inserted into the stream where the length of the inserted content does not have to be the same length of the media that it is replacing. The buffer, in real time as described above, adjusts to output to a second audio card a stream that is ready for encoding and ultimate delivery to the internet for playback by a listener using a decoding player. As shown in FIG. 2, an external audio processor may be used to suit the particular installation and needs of the broadcaster. Any type of encoding and format can be used. For example, Real media encoding is preferred but others, such as Windows Media and Quicktime can be used.

Referring specifically to the FIFO application, it acts like a DVR for audio and other media where it continuously samples from an audio input (in this case, the line-in jack), and stores the result to a buffer. It plays the audio out from that buffer into Windows. An IP interface will be needed to control input and output functions. It will need to accept ‘start’ and ‘stop’ commands for the input, that control whether input is actively sampled into the buffer. It will also accept ‘play’ and ‘pause’ commands for output. Input and output to the buffer behave separately, and it's very possible to reach an empty buffer point—where we've stopped input, and want to play what's remaining in the buffer. When the buffer is empty, if it hasn't been sent an output pause, it should just idle until output is picked up again.

For Phase I function/interface requirements, an IP connection to the service can be opened. Dynamic port handling can also be employed. The injector will send the following commands (format is wide open for this—we can send readable text, or a short numeric message):
Input: Start recording/appending to buffer
Input: Stop recording/appending to buffer
Output: Play from buffer
Output: Pause play at current position.
Buffer Size Query: Respond with buffer length in milliseconds, or some time measurement (I'd like to get to at least tenths).

The FIFO buffer supports “stop listening” and “start listening”. When started, the application will automatically start up the listening (record) and playback streams. Either tcp (telnet) or the console to issue commands can be used. For example, if the application is started up and a pause command is issued, the output is paused, while the input is still recording and filling up the buffer, then a resume command can be issued, and the stream will be picked up where it was left off, the buffer holding the difference. Additionally, the stop listening command can be issued, and the remainder of the buffer (if applicable) will be played, then silence, after which the start listening command can be issued to resume recording. Thus, the two sets of commands act like valves, and the buffer, a reservoir. At any time the ‘d’ command is issued to see how many seconds of buffer are available, and the ‘c’ command to instantly clear the buffer when it is desired to bring the output back up to real time.

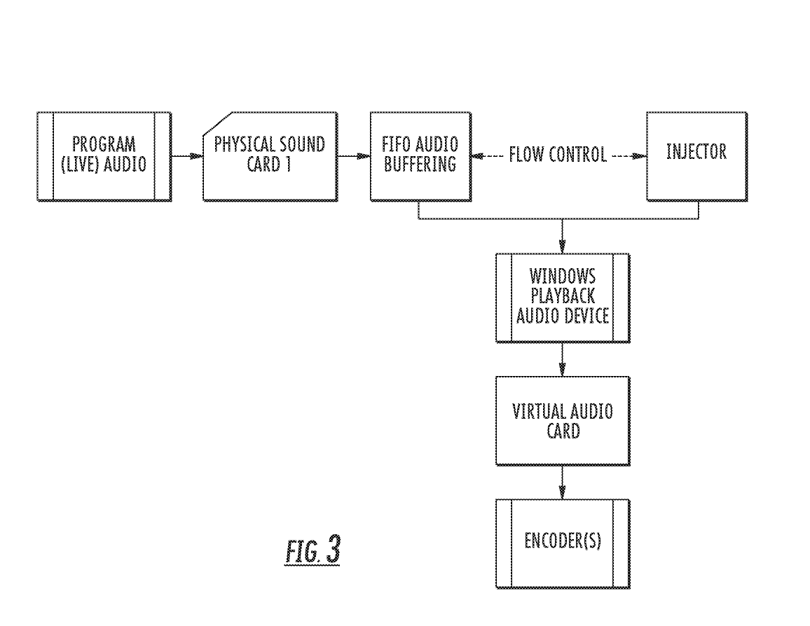

An overview of the method and system of the present invention is shown in FIG. 3 where live audio is fed into a first sound card, the output of which is buffered using the FIFO buffer described above. Additional content is inserted into the stream using an injector to provide a stream for encoding into a format that is suitable for delivery over the Internet or other network and listening by a user using playback media player software.

The present invention in particularly unique in the way that additional content is inserted and buffer so that the length of the inserted content does not have to match the length of the content that it is replacing. In accordance with the present invention a time delay is created on the raw audio signal using a software based delay loop. The audio is delivered into a virtual audio device where the system sees it as a real hardware device, as seen in FIG. 3. Preferably, there are two inputs with flexible pause and resume on the live feed. The present invention unique combines content insertion and buffered playback in the same solution.

The virtual audio device is used as a switching device to enable switching between the two feeds to provide a single output feed therefrom. While typical buffers must match the end of an air feed, the system of the present invention can return to as given point of the live feed regardless of the length of the delay. Thus, the system of the present invention permits the stream audio to be fully synchronized.

In use, for example, there is a desire to insert advertisement or localized or specialized content into to the live stream. This inserted material, as above, does not have to be the same length as what it is replacing. However it is possible that the inserted content is shorter than the content to be replaced. Content from inventory can be used to fill the silence that would result. If it were to go over and into the live feed, the live feed stream can simply be delayed to ensure seamless streaming. If the live feed stream is too far ahead, the buffer can be set to dump the replaced content to catch up with the live feed stream.

The present invention can also be used for a profanity delay. The content buffer as described above can be integrated to delete parts of a stream using the buffer for seamless streaming even if there is a profanity delay.

Thus, the present invention provides an elastic buffer for insertion of content into a media stream where the inserted content does not have to match the content it is replacing. The present invention is described herein using audio streams as an example. It should be understood that any type of media, such as video can also be processed, streamed and played back in accordance with the present invention herein. The inserted content may be advertisements, specialized, localized or any other type of replacement or alternative content.

It would be appreciated by those skilled in the art that various changes and modifications can be made to the illustrated embodiments without departing from the spirit of the present invention. All such modifications and changes are intended to be covered by the appended claims.

What is claimed is:

1. A method of streaming media content, comprising:
inputting the live feed into a first audio card having an output;
inputting the output of the first audio card into a FIFO buffer having an output;
inputting the output of the FIFO buffer into a virtual audio card having an output;
inserting additional content into a second audio card by replacing content to be substituted where the additional content and the content to be replaced do not have to be of the same duration;
mixing the output from the first audio card and the additional content by the second audio card to provide a mixed output;
inputting the mixed output of the second audio card into an encoder having an output;
streaming the output of the encoder over a network.

2. The method of claim 1, wherein the first audio card is a physical audio card.

3. The method of claim 1, wherein the second audio card is a virtual audio card.

4. The method of claim 1, further comprising:
providing control data for controlling the function of the FIFO buffer.

5. The method of claim 4, wherein said control data is selected from the group comprising the commands of: start appending to the FIFO buffer, stop appending to the FIFO buffer, play from the FIFO buffer, pause play at current position within the FIFO buffer, and Query the size of the FIFO buffer.

6. The method of claim 1, further comprising:
providing a delay loop for synchronizing the output of the virtual audio card and the additional content.

7. The method of claim 1, further comprising:
adjusting the size of the FIFO buffer.

8. An apparatus for streaming media content, comprising:
a first audio card having an output configured and arranged to transmit a live feed;
a FIFO buffer having an input communicatingly connected to the output of the first audio card;
a virtual audio card having an output and an input, said input communicatingly connected to the output of the FIFO buffer;
a second audio card configured and arranged to receive the output of the virtual audio card and additional content from another source, the second audio card further configured and arranged to insert said additional content into the output of the virtual audio card by replacing content to be substituted where the additional content and the content to be replaced do not have to be of the same duration;
whereby mixing the output from the virtual audio card and the additional content by the second audio card to provide a mixed output;
an encoder communicatingly connected to the second audio card for encoding the mixed output of the second audio card streaming the encoded mixed output of the over a network.

9. The apparatus of claim 8, wherein the first audio card is a physical audio card.

10. The apparatus of claim 8, wherein the second audio card is a virtual audio card.

11. The apparatus of claim 8, further comprising:
control data for controlling the function of the FIFO buffer.

12. The apparatus of claim 11, wherein said control data is selected from the group comprising the commands of: start appending to the FIFO buffer, stop appending to the FIFO buffer, play from the FIFO buffer, pause play at current position within the FIFO buffer, and Query the size of the FIFO buffer.

13. The apparatus of claim 8, further comprising:
a delay loop for synchronizing the output of the virtual audio card and the additional content.

14. The apparatus of claim 8, wherein the size of the FIFO buffer is adjustable.

15. A method of streaming media content stored on a computer readable medium, comprising:
computer readable instructions for inputting a live feed into a first audio card having an output;
computer readable instructions for inputting the output of the first audio card into a FIFO buffer having an output;
computer readable instructions for inputting the output of the FIFO buffer into a virtual audio card having an output;
computer readable instructions for inserting additional content into a second audio card by replacing content to be substituted where the additional content and the content to be replaced do not have to be of the same duration;
computer readable instructions for mixing the output from the first audio card and the additional content by the second audio card to provide a mixed output;
computer readable instructions for inputting the mixed output of the second audio card into an encoder having an output;
computer readable instructions for streaming the output of the encoder over a network.

16. The method of claim 15, further comprising:
computer readable instructions for providing control data for controlling the function of the FIFO buffer.

17. The method of claim 16, wherein said control data is selected from the group comprising the commands of: start appending to the FIFO buffer, stop appending to the FIFO buffer, play from the FIFO buffer, pause play at current position within the FIFO buffer, and Query the size of the FIFO buffer.

18. The method of claim 15, further comprising:
computer readable instructions for providing a delay loop for synchronizing the output of the virtual audio card and the additional content.

19. The method of claim 15, further comprising:
computer readable instructions for adjusting the size of the FIFO buffer.
